(19) United States
(12) Patent Application Publication
(10) Pub. No.: US 2024/0413846 A1
(43) Pub. Date: Dec. 12, 2024

(54) METHOD FOR MANAGING A RADIO INTERFACE OF A COMMUNICATION DEVICE

(71) Applicant: SAGEMCOM BROADBAND SAS, Bois-Colombes (FR)

(72) Inventor: Samira MAPAR, Bois-Colombes (FR)

(73) Assignee: SAGEMCOM BROADBAND SAS, Bois-Colombes (FR)

(21) Appl. No.: 18/678,770

(22) Filed: May 30, 2024

(30) Foreign Application Priority Data
Jun. 9, 2023 (FR) 2305833

(51) Int. Cl. H04B 1/00; H04B 1/04; H04B 1/16

(52) U.S. Cl. CPC H04B 1/0067; H04B 1/04; H04B 1/1607; H04B 2001/0408

(57) ABSTRACT

A method and a device for managing a radio interface of a communication device, the radio interface includes a plurality of antennas suitable for transmitting and receiving data frames, a front-end module being associated with each antenna, each front-end module comprising a chain for transmitting and a chain for receiving data frames. According to the invention for each antenna and the associated front-end module, a measurement of the received power level is obtained, each power level obtained is compared with a decision threshold determined from at least some of the measurements of power levels of received signals. If the power level of the signal received for an antenna and the associated front-end module is below the decision threshold, the front-end module is deactivated for transmitting a data frame.

### TECHNICAL FIELD

The present invention relates to a method for managing a radio interface of a communication device comprising a plurality of antennas.

### PRIOR ART

In radio communication networks, such as for example communication networks using Wi-Fi technology, the radio interfaces of communication devices have available respectively a set of functionally bidirectional antennas for data transmission and reception. The use of a plurality of antennas is known by the acronym MIMO (standing for Multiple-Input Multiple-Output).

It is a multiplexing technique used in wireless networks such as mobile and Wi-Fi networks that allows longer-range data transfers with a higher throughput than with a single antenna.

The components implementing MIMO technology are based on the almost-real-time characterisation of the propagation channel by means for example of return error indicators, for adjusting the transmission parameters (power, modulation type, channel coding, etc) with a view to obtaining the best throughput to a receiver. This operation is performed conjointly by the transmitter and the receiver.

MIMO technology, through its structure, enables each of the antennas of a receiver to receive a combination of signals coming from each of the transmission antennas used in the transmitter.

Depending on the propagation conditions, the signal transmitted by one or more antennas may be very greatly degraded and it may happen that the signal received by at least one antenna of the destination communication device represents only a tiny proportion of the total useful signal perceived by each of antennas of the destination communication device. A plurality of electronic components for transmitting and receiving the audio signals are associated with each antenna. These electronic components are often included in a module called a front-end module. A front-end module comprises, for example, at least one power amplifier, at least one low-noise amplifier and at least one multiplexer or a switch. The components of the front-end module consume electrical energy. When a signal received by at least one antenna is greatly degraded, it is not significantly involved in the reconstruction of the data signal by the communication device whereas transmitting said signal consumes electrical energy.

It is in particular desirable to provide a solution that optimises the consumption of electrical energy of communication devices using MIMO technology.

### DISCLOSURE

A method is proposed for managing a radio interface of a communication device, the radio interface comprising a plurality of antennas suitable for transmitting and receiving data frames, a front-end module being associated with each antenna, each front-end module comprising a chain for transmitting and a chain for receiving data frames, characterised in that the method comprises the steps of:
obtaining, for each antenna and the associated front-end module, a measurement of the power level of the signal received,
comparing each power level obtained with a decision threshold determined from at least some of the measurements of power levels of the signals received,
if the power level of the signal received for an antenna and the associated front-end module is below the decision threshold, deactivating the front-end module for transmitting a data frame.

One or more embodiments also relate to a device for managing a radio interface of a communication device, the radio interface comprising a plurality of antennas suitable for transmitting and receiving data frames, a front-end module being associated with each antenna, each front-end module comprising a chain for transmitting and a chain for receiving data frames, characterised in that the management device comprises:
means for obtaining, for each antenna and the associated front-end module, a measurement of the power level of the signal received,
means for comparing each power level obtained with a decision threshold determined from at least some of the measurements of power levels of the signals received,
means for deactivating a front-end module for transmitting a data frame if the power level of the signal received for an antenna and the associated front-end module is below the decision threshold.

Thus the electrical energy consumption of the communication devices using MIMO technology is optimised without detriment to the reception quality of the data frames.

According to a particular embodiment, the decision threshold is determined from a mean of the measurements of power levels of received signals minus a predefined value.

According to a particular embodiment, the predefined value is dependent on the type of modulation used for transferring a data frame.

According to a particular embodiment, the part of the measurements of power levels of the received signals for determining the decision threshold comprises a predefined number of measurements of power levels of received signals that are highest among the measurements of power levels of the received signals.

According to a particular embodiment, the predefined number is equal to at least 1.

According to a particular embodiment, the deactivation of front-end modules is limited to the total number of front-end modules minus one.

According to a particular embodiment, the maximum number of front-end modules that can be deactivated is dependent on the type of modulation used for transmitting data frames.

According to a particular embodiment, the method is implemented prior to transmitting each data frame during a predetermined period.

A computer program, which can be stored on a medium and/or downloaded from a communication network, in order to be read by a processor, is also proposed.

This computer program comprises instructions for implementing the method implemented by the management device as mentioned above, when said program is executed by the processor. One embodiment also relates to an information storage medium storing such a computer program.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically an arrangement of a wireless communication network according to one embodiment;

FIG. 2 illustrates schematically an example of front-end modules of a radio interface included in a communication device;

FIG. 3 illustrates schematically an example of hardware arrangement of a telecommunication device;

FIG. 4 illustrates schematically an example of an algorithm executed by a communication device.

### DETAILED DISCLOSURE OF EMBODIMENTS

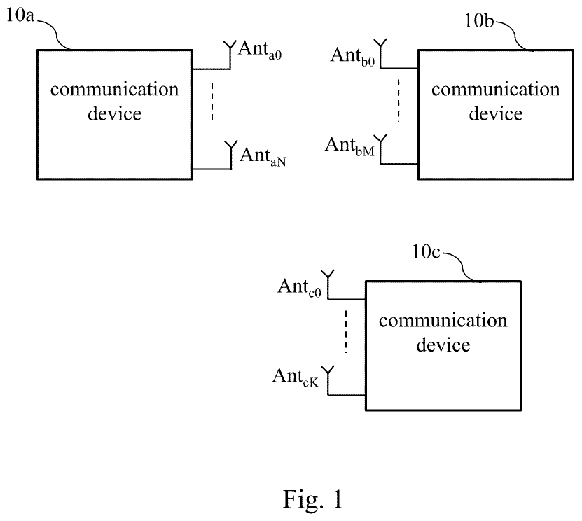

FIG. 1 illustrates schematically an arrangement of a wireless communication network according to one embodiment.

In the example in FIG. 1, three communication devices 10a, 10b and 10c are shown.

Naturally, the various embodiments are applicable to a greater or lesser number of communication devices.

The communication network is for example and non-limitatively a communication network using for example Wi-Fi technology or a mobile-telephony communication network.

The communication devices 10a, 10b and 10c are for example access points of a domestic communication network, stations, gateways or Wi-Fi repeaters.

The communication device 10a comprises N+1 antennas denoted Antₐ₀ to Ant_{aN}, the communication device 10b comprises M+1 antennas denoted Antbo to Ant_{bM} and the communication device 10c comprises K+1 antennas denoted Ant_{c0} to Ant_{cK} where N, M and K are integers greater than or equal to 1.

For example, if N and M are equal to 1, the communication device 10a is able to transfer data to the communication device 10b by means of a propagation channel between the antenna Antₐ₀ and the antenna Ant_{b0} denoted C_{a0b0}, a propagation channel between the antenna Antₐ₁ and the antenna Ant_{b0} denoted C_{a1b0}, a propagation channel between the antenna Antₐ₀ and the antenna Ant_{b1} denoted C_{a0b1}, and a propagation channel between the antenna Antₐ₁ and the antenna Ant_{b1} denoted C_{a1b1}.

$$[ \begin{matrix}B 0 \\ B 1\end{matrix} ] = [ \begin{matrix}{C}_{a 0 b 0} & {C}_{a 1 b 0} \\ {C}_{a 0 b 1} & {C}_{a 1 b 1}\end{matrix} ] \times [ \begin{matrix}A 0 \\ A 1\end{matrix} ] = C \times A where C = [ \begin{matrix}{C}_{a 0 b 0} & {C}_{a 1 b 0} \\ {C}_{a 0 b 1} & {C}_{a 1 b 1}\end{matrix} ] , \\ A = [ \begin{matrix}A 0 \\ A 1\end{matrix} ] , B = [ \begin{matrix}B 0 \\ B 1\end{matrix} ]$$

B0 being the signal received by the antenna Ant_{b0} of the communication device 10b and B1 the signal received by the antenna Ant_{b1} of the communication device 10b, A0 is the signal transmitted by the antenna Antₐ₀ and A1 the signal transmitted by the antenna Antₐ₁.

In a conventional propagation environment with obstacles such as passive elements, it is acceptable to apply the reciprocity principle. Thus the propagation channels between each pair of antennas of the communication devices 10a and 10b have the same characteristics whatever the transmission and reception direction.

Each antenna and its associated front-end module of the communication device 10a perceives the communication device 10b as a single transmission source. The number and characteristics of each antenna and its associated front-end module of the communication device 10b are not distinguished by the communication device 10a. The same principle is applicable to the communication device 10b.

A wireless communication in accordance with the MIMO mode between two communication devices, for example 10a and 10b, uses on both sides a plurality of transmission chains and a plurality of reception chains.

The communications from the communication device 10a to the communication device 10b use the same frequency channel, or close frequency channels in one and the same frequency band, and travel over the same airspace at different but very close instants (for example a few ms). It is therefore considered that the communication channel is reciprocal.

In general, a communication is bidirectional since the transmission of a data frame by a communication device is followed by the transmission in response of an acknowledgement by the destination communication device. By default, the transmissions and receptions on both sides take place using all the transmission and reception chains.

Combining in the receiver the information coming from the various antennas, in accordance with the MIMO principles, makes it possible to reconstruct the data stream transmitted, the data having been configured in accordance with the MIMO principles by the transmitter in order to be transmitted via its antennas.

The ability of the receiver to reconstruct the input data is highly dependent on the quality of the signal that it receives from each of its reception chains. The quality of this signal is itself dependent on the signal-to-noise ratio of the signal arriving at the antenna associated with the reception chain.

The signal received with low amplitude, or a low signal-to-noise ratio, therefore, de facto, contributes less to the reconstruction of the data stream than a signal received with high amplitude or a high signal-to-noise ratio.

It is notable that a reception chain showing a low received-signal amplitude, or low signal-to-noise ratio, compared with the amplitude or signal-to-noise ratio of the other reception chains, shows a poor performance of the propagation channel to which it relates.

Given the phenomenon of reciprocity of the propagation channel, it is notable also that a signal transmitted by a transmission chain using the same antenna will be degraded in the same way when it arrives on the antennas of the remote receiver.

The method described below makes it possible to judge the level of contribution of each of the propagation channels on the basis of a received level, and to deduce therefrom the relevance of activation of the corresponding transmission chain.

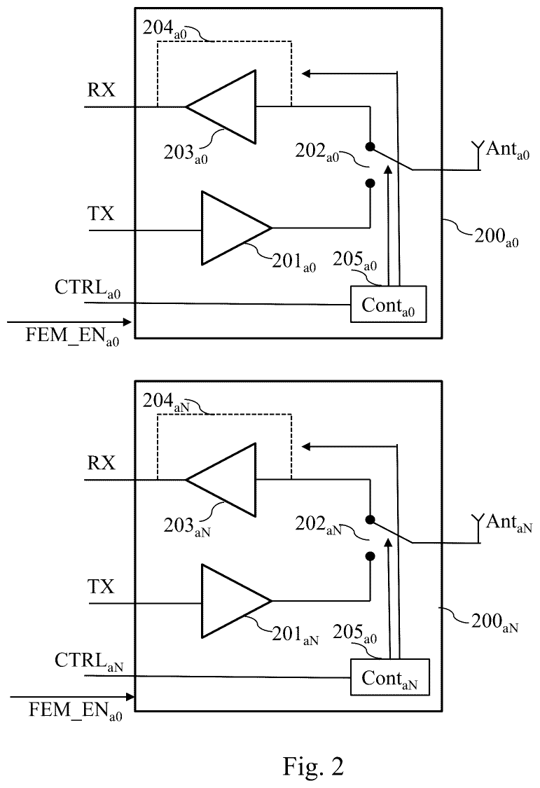

FIG. 2 illustrates schematically an embodiment of the front-end modules of a radio interface included in a communication device.

In the example in FIG. 2, the front-end modules of the radio communication interface included in the communication device 10a are shown.

The front-end module 200ₐ₀ is associated with the antenna Antₐ₀ and the front-end module 200_{aN} is associated with the antenna Ant_{aN}.

The front-end module 200ₐ₀ comprises a power amplifier 201ₐ₀, a low-noise amplifier 203ₐ₀, a switch 202ₐ₀, a control circuit Contₐ₀ 205ₐ₀ and a bypass circuit 204ₐ₀ of the low-noise amplifier 203ₐ₀.

The low-noise amplifier 203ₐ₀, the switch 202ₐ₀ and the bypass circuit 204ₐ₀ of the low-noise amplifier 203ₐ₀ form a reception chain.

The power amplifier 201ₐ₀ and the switch 202ₐ₀ form a transmission chain.

The front-end module 200ₐ₀ can also comprise at least one filter, not shown in FIG. 2.

When the communication device 10a transmits a data frame, the latter is modulated and transmitted to the power amplifier 201ₐ₀ by the connection denoted TX. At least one control signal CTRLₐ₀ indicates to the control circuit Contₐ₀ 205ₐ₀ that it is necessary to position the switch 202ₐ₀ so that the output signal of the power amplifier 201ₐ₀ is directed to the antenna Antₐ₀.

When the communication device 10a receives a data frame, the signal received by the antenna Antₐ₀ is transmitted to the low-noise amplifier 203ₐ₀ in order to be amplified and transmitted to the radio interface 305 of the communication device 10a for demodulation and processing by means of the RX link. Optionally, if the amplitude of the received signal is above a predetermined threshold, the signal received by the antenna Antₐ₀ is transmitted via the bypass circuit 204ₐ₀ of the low-noise amplifier 203ₐ₀.

A signal denoted FEM_ENₐ₀ makes it possible to activate or not the supply of electrical energy to the front-end module 200ₐ₀.

The front-end module 200_{aN} comprises a power amplifier 201_{aN}, a low-noise amplifier 203_{aN}, a switch 202_{aN}, a control circuit Cont_{aN} 205_{aN} and a bypass circuit 204N of the low-noise amplifier 203_{aN}.

The low-noise amplifier 203_{aN}, the switch 202N and the bypass circuit 204_{aN} of the low-noise amplifier 203_{aN} form a reception chain.

The power amplifier 201N and the switch 202N form a transmission chain.

The front-end module 200_{aN} can also comprise at least one filter, not shown in FIG. 2.

When the communication device 10a transmits a data frame, the latter is modulated and transmitted to the power amplifier 201N by the connection denoted TX. At least one control signal CTRL_{aN} indicates to the control circuit 205_{aN} that it is necessary to position the switch 202N so that the output signal of the power amplifier 201_{aN} is directed to the antenna Ant_{aN}.

When the communication device 10a receives a data frame, the signal received by the antenna Ant_{aN} is transmitted to the low-noise amplifier 203_{aN} in order to be amplified and transmitted to the radio interface 305 of the communication device 10a for demodulation and processing by means of the RX link. Optionally, if the amplitude of the received signal is above a predetermined threshold, the signal received by the antenna Ant_{aN} is transmitted to the bypass circuit 204_{aN} of the low-noise amplifier 203_{aN}.

A signal denoted FEM_EN_{aN} makes it possible to activate or not the supply of electrical energy to the front-end module 200_{aN}.

When a front-end module 200ₗ, with l=0 to N, is activated, the front-end module 200ₗ is supplied with electrical energy and allows reception and transmission of data frames by means of the front-end module 200ₗ and the antenna with which the front-end module is associated. When a front-end module 200ₗ is deactivated, the front-end module 200ₗ is not supplied with electrical energy and does not allow reception and transmission of data frames by means of the front-end module 200ₗ and the antenna with which the front-end module 200ₗ is associated.

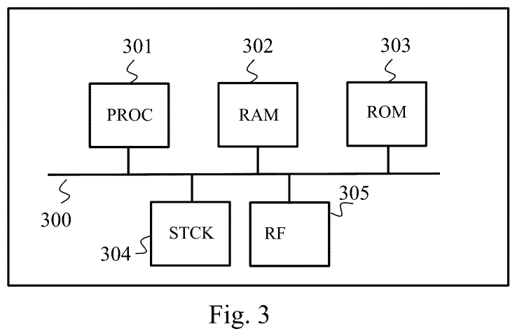

FIG. 3 illustrates schematically an example of hardware arrangement of a telecommunication device;

The example of hardware arrangement presented comprises, connected by a communication bus 300: a processor PROC 301; a random access memory (RAM) 302; a read only memory (ROM) 303, or a flash memory; a storage unit or a storage medium reader (“STCK”), such as an SD (Secure Digital) card reader 304 or a hard disk drive (HDD); and an RF radio interface 305.

The processor CPU 301 is capable of executing instructions loaded in the RAM 302 from the ROM 303, from an external memory (such as an SD card), from a storage medium (such as the hard disk HDD), or from a communication network. When the communication device is powered up, the processor CPU 301 is capable of reading instructions from the RAM 302 and executing them. These instructions form a computer program causing the implementation, by the processor CPU 301, of all or some of the behaviours, algorithms and steps described here.

Thus all or some of the algorithms and steps described here can be implemented in software form by executing a set of instructions by a programmable machine, such as a DSP (“digital signal processor”), or a microcontroller or a processor. All or some of the algorithms and steps described here can also be implemented in hardware form by a machine or a component (chip), such as an FPGA (“field-programmable gate array”), or an ASIC (“application-specific integrated circuit”). Thus the communication device comprises electronic circuitry adapted and configured to implement the behaviours, algorithms and steps described here.

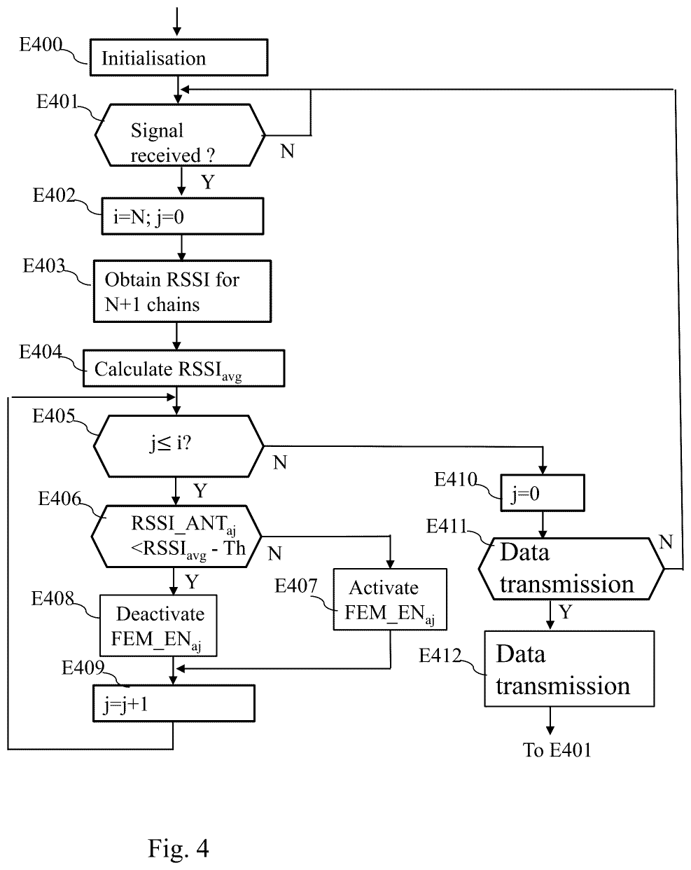

FIG. 4 illustrates schematically an example of an algorithm executed by a communication device.

The present algorithm is described in an example in which it is executed by the communication device 10a.

It should be noted here that, for reasons of speed of execution of the present algorithm, the present algorithm can be executed by the radio interface 305 of the communication device 10a. In another embodiment, the present algorithm can be executed by the processor 301 in cooperation with the front-end module such as the front-end module 200ₐ₀.

At the step E400, the present algorithm is initialised. It is executed iteratively.

At the step E401, the communication device 10a checks whether a signal transmitted by another communication device is received. If so, the communication device 10a identifies the communication device that transmitted the signal received and passes to the step E402. The identification is for example made from the MAC (Media Access Control) address, or BSSID (Basic Service Set Identifier) address for a Wi-Fi device, or the IMEI (International Mobile Equipment Identity) address for cellular equipment. If not, the communication device 10a returns to the step E401.

In one embodiment, the verification of the reception of a signal transmitted by another communication device is replaced by a time delay equal for example to one second.

In one embodiment, the verification of the reception of a signal transmitted by another communication device is replaced by a verification of the reception of a predetermined data frame such as for example a frame requesting association with the communication network.

It should be noted here that the aforementioned embodiments can also be combined.

At the step E402, the communication device 10a initialises a variable denoted i to the number of antennas that the communication device 10a has, in this case N+1 for the communication device 10a, and sets a variable denoted j to the value 0.

At the step E403, the communication device 10a obtains, for each antenna, a measurement of the power level of the received signal RSSI (the acronym of Received Signal Strength Indicator or Received Signal Strength Indication).

The communication device 10a obtains from each antenna Antₐ₀ to Ant_{aN} respectively a measurement of the power level of the received signal RSSI_Antₐ₀ to RSSI_Ant_{aN}.

According to the characteristics of the propagation channel relating to each reception frame comprising the diagram and the polarisation of its associated antenna, the RSSI levels of the various chains may be very heterogeneous. For example, in the case of the Wi-Fi system, its value may vary in the range from approximately −30 dBm for a signal received under very good conditions from a nearby transmitter up to approximately −98 dBm for a signal received very weakly, for example from a very distant transmitter or under very bad propagation conditions.

The RSSI measurements provide an indication on the performances of the corresponding propagation channels since the distant communication device transmits with a homogeneous power to each of these channels. The signal received locally by each of the antennas directly reflects the attenuation of the corresponding propagation channel.

Since the channel is by definition symmetrical, its characteristics of propagation to the distant communication device can be deduced directly from the corresponding RSSI level.

For example, the control device, in order to obtain the RSS measurements of the last frame received from the radio interface 305, makes a command “w1 sta_info <xx:xx:xx:xx:xx:xx>”, where <xx:xx:xx:xx:xx:xx> designates the MAC address of the device, and may obtain the following result:

“per antenna rssi of last rx data frame: −73 −83 −71 −71”, where the numerical values represent the RSSI in dBm for each of the antennas.

At the following step E404, the communication device calculates an average RSSI_{avg} of the values of the power level measurements of the received signals RSSI_Antₐ₀ to RSSI_Ant_{aN}.

At the following step E405, the communication device 10a checks whether the value of the variable j is less than or equal to the value of the variable i.

If so, the communication device 10a passes to the step E406. If not, the communication device 10a returns to the step E401 to recommence listening on the channel.

At the step E406, the communication device 10a checks whether the measurement of the received power level RSSI_Antₐj is strictly less than a decision threshold determined from at least some of the measurements of power levels of received signals.

For example, the decision threshold is the average RSSI_{avg} of the values of the power level measurements of the received signals RSSI_Antₐ₀ to RSSI_Ant_{aN} minus a threshold denoted Th. The threshold Th is for example equal to 10 dB. It should be noted here that the value of the threshold Th can be modified according to certain conditions explained hereinafter.

For example, the part of the measurements of power levels of received signals for determining the decision threshold comprises a predefined number of measurements of power levels of received signals that are highest among the measurements of power levels of the received signals.

For example, the predefined number is equal to at least one.

For example, the control device, in order to obtain the RSSI average of the radio interface 305, makes the command “w1 sta_info <xx:xx:xx:xx:xx:xx>”, where <xx:xx:xx:xx:xx:xx> designates the MAC address of the device, can produce the following result:

“per antenna average rssi of rx data frames: −73 −83 −71 −71”, where the numerical values represent the RSSI in dBm for each of the antennas.

If the difference between these RSSI values is very large, the reception chain that receives less energy can therefore be considered to be non-contributing for the distant communication device identified from the MAC address or the BSSID or the IMEI, and the front-end module can be deactivated during the next transmission to the communication device that transmitted the signal received at the step E401.

One of the ways of identifying the non-contributing chains is to calculate the difference between the RSSI of each reception chain and the average RSSI of all the reception chains.

The RSSI average is for example calculated in watts unit. If the RSSI is expressed in dBm, it is then necessary to convert it into watts.

Next, the RSSI of each antenna is compared with the average of the RSSIs. If the difference exceeds a predefined threshold, the corresponding chain will be identified as non-contributing.

This is because the contribution of one of the reception chains to the reconstruction of the signal transmitted by the distant transmitter will be all the smaller, the lower the level of the signal received by this chain.

Let us take for example a case in which the communication device 10a comprises four antennas Antₐ₀ to Antₐ₃.

The measurements of the RSSI values of the last frame received are evaluated for each of the antennas at respectively RSSI_Antₐ₀=−73 dBm, RSSI_Antₐ₁=−83 dBm, RSSI_Antₐ₂=−71 dBm and RSSI_Antₐ₃=−71 dBm.

To obtain the decision threshold determined from at least some of the measurements of power levels of the signals received, it is possible to proceed thus:
RSSI_Antₐ₀=−73 dBm, i.e. 50 nW
RSSI_Antₐ₁=−83 dBm, i.e. 5 nW
RSSI_Antₐ₂=−71 dBm, i.e. 79 nW
RSSI_Antₐ₃=−71 dBm, i.e. 79 nW
RSSI_{avg}=the sum of the RSSIs of the antennas Antₐ₀ to Antₙ₃ divided by the number of antennas:
RSSI_{avg}=53 nW, i.e. −72.7 dBm
Decision threshold=RSSI_{avg}−Th=−72.7 dBm−10 dB=−82.7 dBm

The step 406 compares the RSSIs of the last frame received with the threshold:
RSSI_Antₐ₀: −73 dBm is above the decision threshold of −82.7 dBm
RSSI_Antₐ₁: −83 dBm is below the decision threshold
RSSI_Antₐ₂: −71 dBm is above the decision threshold
RSSI_Antₐ₃: −71 dBm is above the decision threshold

In this example, it is clear that the antenna chain Antₐi is identified as non-contributing.

In this example, it is considered that the communication device 10a comprises 4 antennas, each associated with a front-end module. In other examples, a communication device having a different number of antennas and of front-end modules can implement one or more embodiments:
communication device comprising 2 antennas;
communication device comprising 3 antennas;
communication device comprising 6 antennas;
communication device comprising 8, 16, 64 antennas;
etc.

According to one variant embodiment, the threshold value Th depends on the type of modulation used for the next transmission or on the MIMO scheme used, or on the average RSSI level when it is above a given threshold corresponding for example to excellent propagation conditions, or for example to very poor propagation conditions.

In one example, the value of the threshold Th is selected close to 3 dB, i.e. the threshold Th represents an identification of a non-contributing antenna when the latter receives a signal with half the energy or power of the average of the energies or powers of the signals received by all the antennas. In another example, the value of the threshold is selected close to 15 dB. In yet another example, the value of the threshold is selected in the interval]0 dB, 20 dB].

If so, the communication device 10a passes to the step E408. If not, the communication device 10a passes to the step E407.

At the step E407, the communication device 10a demands, for the next transmission of a data frame intended for the communication device that transmitted the signals received at the step E401, activation of the signal FEM_ENₐⱼ. In other words, the communication device activates or maintains the electrical energy supply to the front-end module 200ₐⱼ for the next transmission of a data frame intended for the communication device that transmitted the signals received at the step E401.

Once this operation has been performed, the communication device passes to the step E409.

At the step E408, the communication device 10a demands, for the next transmission of a data frame intended for the communication device that transmitted the signals received at the step E401, deactivation of the signal FEM_ENₐⱼ. In other words, the communication device deactivates the electrical energy supply to the front-end module 200ₐⱼ for the next transmission of a data frame intended for the communication device that transmitted the signals received at the step E401.

For example, the following commands are used:
“wl txchain <xy>”, which allows control of the chains to be used for transmission.
“wl rxchain <xy>”, which allows control of the chains to be used for reception.

According to one variant, the deactivation decision is limited to a single front-end module among the plurality of front-end modules, or to two front-end modules.

According to another variant, the deactivation decision is taken according to one antenna crossing a threshold relating to another antenna, for example with respect to the better antenna or with respect to the two best.

According to yet another variant, the deactivation decision relates to the deactivation of a single antenna among the plurality of antennas that can be excluded, for example the worst, or the two worst.

According to another alternative, the maximum number of front-end modules that can be deactivated is dependent on the modulation used for transmitting the next data frame.

At the following step E409, the communication device 10a increments the variable j by one unit and returns to the step E405.

Thus the following command makes it possible to interrupt the supply of electrical energy to the transmission chain of the front-end module 200ₐ₁ during the next transmission:
“wl txchain 13”
13=(1101)_{b}→the FIG. 0, in the second column, shows that the second transmission chain will be deactivated.

Once this operation has been performed, the communication device returns to the step E401.

According to a particular embodiment, for transmitting the beacon signals at regular intervals, all the front-end modules are activated.

In a particular embodiment, the algorithm as described is interrupted at regular intervals to enable the communication devices to activate all their frontal channels and thus to allow full evaluation of the propagation channels in the case of improvement in the propagation conditions between the two communication devices. The interruption can for example be implemented for transmitting five frames every 5 s.

1. A method for managing a radio interface of a communication device, the radio interface comprising a plurality of antennas suitable for transmitting and receiving data frames, a front-end module being associated with each antenna, each front-end module comprising a chain for transmitting and a chain for receiving data frames, wherein the method comprises the steps of:
obtaining, for each antenna and the associated front-end module, a measurement of the power level received,
comparing each power level obtained with a decision threshold determined from at least some of the measurements of power levels of signals received,
if the power level of the signal received for an antenna and the associated front-end module is below the decision threshold, deactivating the front-end module for transmitting a data frame.

2. The method according to claim 1, wherein the decision threshold is determined from a mean of the measurements of power levels of received signals minus a predefined value.

3. The method according to claim 2, wherein the predefined value is dependent on the type of modulation used for transferring a data frame.

4. The method according to claim 1, wherein the part of the measurements of power levels of received signals for determining the decision threshold comprises a predefined number of measurements of power levels of received signals that are highest among the measurements of power levels of the received signals.

5. The method according to claim 4, wherein the predefined number is equal to at least 1.

6. The method according to claim 1, wherein the deactivation of front-end modules is limited to the total number of front-end modules minus one.

7. The method according to claim 1, comprising a maximum number of front-end modules that can be deactivated is dependent on the type of modulation used for transmitting data frames.

8. The method according to claim 1, wherein the method is implemented prior to transmitting each data frame during a predetermined period.

9. A device for managing a radio interface of a communication device, the radio interface comprising a plurality of antennas suitable for transmitting and receiving data frames, a front-end module being associated with each antenna, each front-end module comprising a chain for transmitting and a chain for receiving data frames, wherein the management device comprises:
means for obtaining, for each antenna and the associated front-end module, a measurement of the power level received,
means for comparing each power level obtained with a decision threshold determined from at least some of the measurements of power levels of signals received,
means for deactivating a front-end module for transmitting a data frame if the power level of the signal received for an antenna and the associated front-end module is below the decision threshold.

10. The computer program product comprising instructions for implementing, by a processor, the method according to claim 1, when said program is executed by said processor.

11. An information storage medium storing a computer program comprising instructions for implementing, by a processor, the method according to claim 1, when said program is read and executed by said processor.
